(19) United States
(12) Patent Application Publication
(10) Pub. No.: US 2012/0275851 A1
(43) Pub. Date: Nov. 1, 2012

(54) AXLE-BORE CONNECTION

(76) Inventor: Arne Aarre, Sandnes (NO)

(21) Appl. No.: 13/512,288

(22) PCT Filed: Nov. 24, 2010
(86) PCT No.: PCT/NO2010/000428

§ 371 Date: May 25, 2012

(30) Foreign Application Priority Data
Nov. 26, 2009 (NO) 200993422

(51) Int. Cl. F16C 3/12

(52) U.S. Cl. 403/314

(57) ABSTRACT

A device for an axle-bore connection wherein an axle runs through a bore in a machine element and wherein a clampable element encircles the axle in the bore, and wherein the clampable element is accessible from only one of the end portions of the bore, and wherein the clampable element has a first set of contact faces near the first end portion of the bore and a second set of contact faces near the second end portion of the bore.

This invention relates to an axle-bore connection. More particularly it concerns an axle-bore connection wherein an axle runs through a bore in a machine element and wherein a clampable element encircles the axle in the bore.

It is known to be able to fit an axle in an axle-bore connection by means of a clampable element. Clampable elements according to prior art are often provided with at least one tapered surface and generally work according to the principle that they by axial displacement in over the axle are clamped between the axle and the bore. NO 302059 describes a clampable element where a clampable element is clamped at each end portion of the axle.

In some applications it is not possible to access more than one end portion of the bolt or the bore. Under such conditions a common clamping element running over a substantial portion of the bolt length in the bore may be used. It occurs however that the axle and the bore are differently loaded at the two end portions of the bore. A need may then arise to be able to tighten the clamping element differently at the two end portions. This may for example occur when the axle forms a singly supported crankshaft running in a bore through a crank arm. The radial forces acting on the axle at the crank-bearing end of the bore is significantly bigger than in the opposing end portion of the axle.

Known clampable elements usable where only one of the end portions of the bolt or bore is accessible, are unsuitable to be able to be tightened differently at the two end portions of the bore.

The object of the invention is to remedy or reduce at least one of the disadvantages of the prior art.

The object is achieved in accordance with the invention by the features disclosed in the below description and in the subsequent claims.

There is provided an axle-bore connection wherein an axle runs through a bore and wherein a clampable element encircles the axle in the bore, as the clampable element is accessible from only one of the end portions of the bore, and wherein the axle-bore connection is characterised in that the clampable element has a first set of contact faces near the first end portion of the bore and a second set of contact faces near the second end portion of the bore.

The first set of contact faces and the second set of contact faces may be differently clampable.

In that the first set of contact faces may be tightened differently relative to second set of contact faces, the two sets of contact faces may be post-tightened differently, such as by different wear at the two end portions of the bore, even if there is no access to the bore from more than one end portion.

The clampable element may have a clearance to at least the bore or the axle in an intermediate portion between the first and the second end portions of the bore.

The first set of contact faces and the second set of contact faces of the clampable element may be positioned on the same piece of material or on different pieces of material. The design must be adapted to the relevant dimensions and spaces.

The first set of contact faces of the clampable element may comprise an external contact face and an internal contact face and the second set of contact faces element may comprise an external contact face and an internal contact face, as the contact faces of the first contact faces and the inner or outer contact faces of the second set may be positioned on a first piece of material, while the rest of the inner or outer contact face of the second set of contact faces may be positioned on a second piece of material.

It is thereby possible to first clamp the first set of contact faces and thereafter clamp the second set of contact faces from one and the same side of the bore.

At least the bore or the axle may be provided with a tapered portion abutting at least one of the contact faces of the first or second set of contact faces.

The second piece of material in the form of a second sleeve may encircle a first sleeve constituted by the first piece of material, or the first sleeve may encircle the second sleeve.

The device according to the invention makes possible a significantly improved clamping of an axle in a bore where there is different loading at the two end portions of the bore and where access for clamping is only possible from one of the end portions of the bore.

In the following is described an example of a preferred embodiment illustrated in the accompanying drawings, wherein:

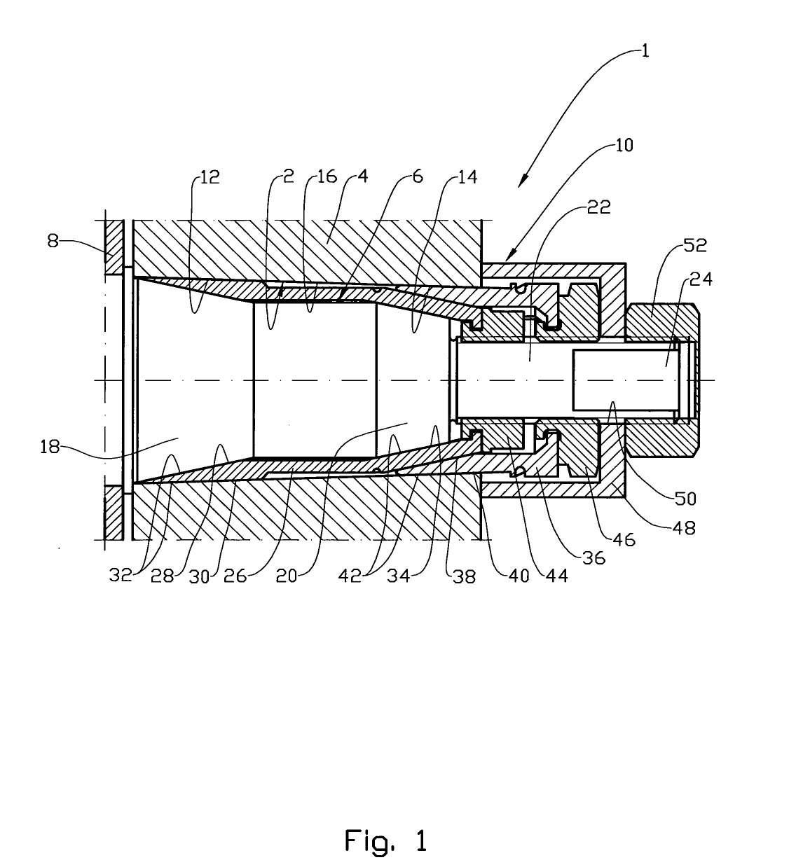

FIG. 1 shows a longitudinal section of an axle-bore connection according to the invention;

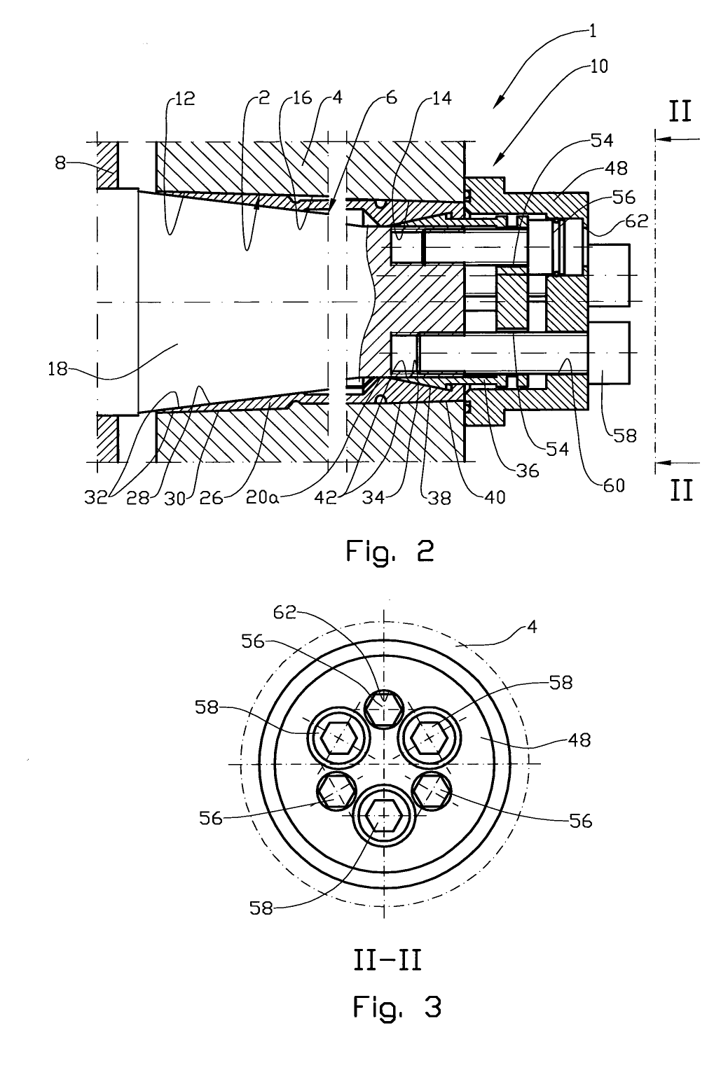

FIG. 2 shows a longitudinal section of an axle-bore connection in an alternative embodiment;

FIG. 3 shows an end view of the axle-bore connection of FIG. 2; and

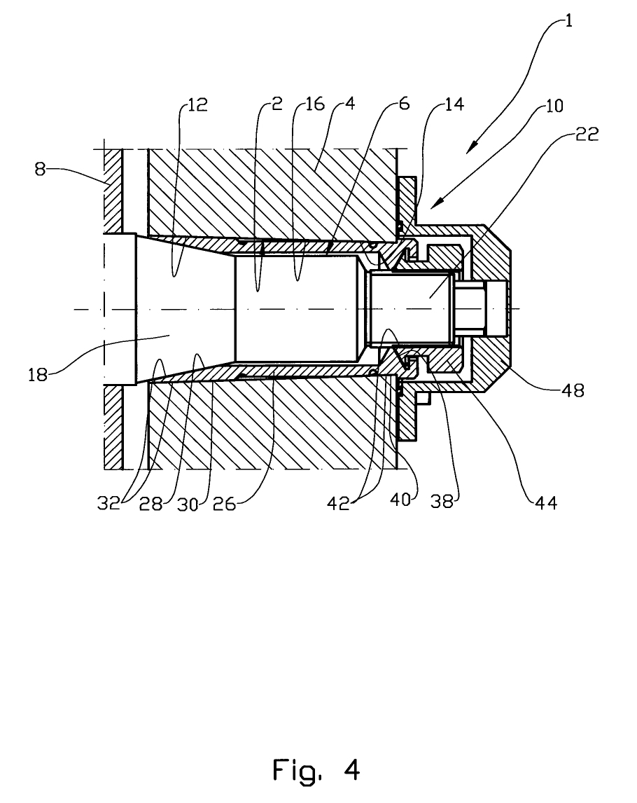

FIG. 4 shows a longitudinal section of an axle-bore connection in a further embodiment.

In the drawings the reference numeral 1 indicates an axle-bore connection comprising a through bore 2 in a machine element 4, here in the form of a crank arm, an axle 6, here in the form of a crankshaft having a fitted crank bearing 8, and also a clampable element 10. The crank bearing 8 may for example be positioned on a not shown jacking pump stay.

The bore 2 comprises a first end portion 12 positioned nearest to the crank bearing 8 and an opposing second end portion 14. An intermediate portion 16 is positioned between the first end portion 12 and the second end portion 14 in the bore 2. In this preferred embodiment the bore 2 is faintly tapered having its largest diameter at the first end portion 12.

The axle 6, which is concentric in the bore 2, comprises a first tapered portion 18 axially corresponding to the first end portion 12 of the bore 2, and a second tapered portion 20 corresponding to the second end portion 14 of the bore 2. A centrally threaded pin 22 that on its outer portion is provided with key flats 24, extends from the axle 6 and out from the bore 2.

A first sleeve 26 is provided with an internal contact face 28 abutting the first tapered portion 18, and with an external contact face 30 abutting the first end portion 12 of the bore 2. The contact faces 28, 30 constitute a first set of contact faces 32.

The first sleeve 26 is further provided with an internal contact face 34 abutting the second tapered portion 20. The first sleeve 26 has a clearance against the intermediate portion 16 of the bore 2 and against the axle between the first tapered portion 18 and the second tapered portion 20.

A second sleeve 36 encircles a tapered clamping portion 38 on the first sleeve 26 at the internal contact face 34. The second sleeve 36 is provided with an external contact face 40 abutting the second end portion 14 of the bore 2. The internal contact face 34 and the external contact face 40 constitute a second set of contact faces 42.

A first nut 44 on the threaded pin 22 abuts the fist sleeve 26, while the second nut 46 positioned on the same threaded pin 22, abuts the second sleeve 36.

A cup 48 having an opening 50 therethrough adapted to the pin 22, is displaced in over the pin 22, and is clamped against the machine element 4 by a third nut 52 on the pin 22.

When the axle 6 is positioned in the bore 2, the first sleeve 26 is displaced in over the axle 6 until the first set of contact faces 32 abut the first end portion 12 of the bore 2 and the first tapered portion 18 of the axle 6. The desired clamping force is achieved by putting the desired torque on the first nut 44.

It may occur that the internal contact face 34 abutting the second tapered portion 20 of the shaft 6 is clamped on to this portion during the first phase of the fitting. This is however of no consequence as the first sleeve 26 is relatively soft and not supported externally at the second tapered portion 20 during this part of the work.

The second sleeve 36 is thereafter displaced in over the clamping portion 38 on the first sleeve 26 and is torqued by means of the second nut 46 in over the clamping portion 38 until the desired clamping force against the second end portion 14 of the bore is achieved.

The cup 48 is displaced in over the pin 22 and is forced against the machine element by means of the third nut 52. The key flats 24 complementary fitting in the opening 50, prevents the cup 48 from being able to rotate relative to the axle 6.

In an alternative embodiment, see FIGS. 2 and 3, the second contact face 40 of the second set of contact faces 42 is on the first sleeve. The internal contact face 34 of the second set of contact faces 42 is on the second sleeve 36. A cylindrical portion 20a here replaces the second tapered portion 20 of the axle 6 in FIG. 1.

The second sleeve 36 is in this embodiment cup-shaped and provided with openings 54 therethrough for a fist set of bolts 56 and for a second set of bolts 58. The first set of bolts 56 that are threaded into the axle 6, abut the second sleeve 36.

The cup 48 is in this embodiment provided with openings 60 therethrough for the second set of bolts 58 and access openings 62 for the first set of bolts. The second set of bolts 58 are also threaded into the shaft 6.

The first sleeve 26 is arranged to be able to abut the cup 48.

When the axle-bore connection 1 of FIGS. 2 and 3 shall be torqued, the cup 48 is displaced into abutment against the machine element 4. The second set of bolts 58 are torqued, whereby the axle 6, after the first sleeve 26 has reached abutment against the cup 48, is pulled into the first sleeve 26 until the desired preloading is achieved in the first set of contact faces 32.

Thereafter the first set of bolts 56 are torqued via the access openings 62 until the second set of contact faces 42 are preloaded with the desired force.

In a further embodiment, see FIG. 4, the axle-bore connection 1 is given a design adapted to relatively small forces.

The internal contact face 40 of the second set of contact faces 42 is here constituted by the threads of the first nut 44. The first nut 44 is forced against the clamping portion 38 of the first sleeve 26 when the first nut 44 is pulled in over the pin 22.

The cup 48 is in this embodiment threaded on the pin 22 and clamps like in the rest of the embodiment examples against the machine element 4.

1. A device for an axle-bore connection wherein an axle runs through a bore in a machine element and wherein a clampable element encircles the axle in the bore, and wherein the clampable element is accessible from only one of the end portions of the bore, wherein the clampable element has a first set of contact faces near the first end portion of the bore and a second set of contact faces near the second end portion of the bore.

2. Device according to claim 1, wherein the first set of contact faces and the second set of contact faces are differently clampable.

3. Device according to claim 1, wherein the clampable element has a clearance against at least the bore or the axle in an intermediate portion between the first and the second end portion.

4. Device according to claim 1, wherein the first set of contact faces and the second set of contact faces of the clampable element are positioned on the same piece of material.

5. Device according to claim 1, wherein the first set of contact faces and the second set of contact faces of the clampable element are positioned on different pieces of material.

6. Device according to claim 1, wherein the first set of contact faces of the clampable element comprises an external contact face and an internal contact face and the second set of contact faces comprises an external contact face and an internal contact face, as the contact faces of the first set of contact faces and one of the contact faces of the second set of contact faces are on the first piece of material, while the second contact faces of the second set of contact faces are on a second piece of material.

7. Device according to claim 1, wherein at least the bore or the axle is provided with a tapered portion.

8. Device according to claim 1, wherein the second sleeve encircles the first sleeve.

9. Device according to claim 1, wherein the first sleeve encircles the second sleeve.
